(19) United States
(12) Patent Application Publication
(10) Pub. No.: US 2011/0192865 A1
(43) Pub. Date: Aug. 11, 2011

(54) DISPENSER

(76) Inventor: Hae Ryong Jung, Incheon-si (KR)

(21) Appl. No.: 13/018,678

(22) Filed: Feb. 1, 2011

(30) Foreign Application Priority Data
Feb. 5, 2010 (KR) 11089/2010

(51) Int. Cl. B65D 35/28; B67D 7/60

(52) U.S. Cl. 222/95; 222/105; 222/386.5

(57) ABSTRACT

The invention relates a dispenser comprises: an outer container (300), an internal vessel (200) for storing contents and inserted inside the outer container (300), and a pumping part (100) combined in an upper part of the internal vessel (200) and for discharging the contents in the internal vessel (200);
the internal vessel is composed with a material capable of the contraction and expansion; a plurality of wrinkles (210) are formed through a blow injection manner; and the connecting rod (220) for coupling with the pumping part (100), an elastic steel band (420) formed in the outer circumference of the internal vessel (200), and a plurality of an elastic steel pieces (421) formed by cutting out a part of the steel band (420) to stand are formed onto the upper part of the internal vessel, respectively;
the elastic steel piece (421) is gradually risen as the contents within the internal vessel (200) is gradually discharged, as maintaining a state where an end part reaches in contact with each other with an inner surface of the outer container (300);
the contents is discharged (or exhausted) by the compressed air (301) by filling between the outer container (300) and the internal vessel (200).

The dispenser further comprises a compression rubber band (410) in an outer circumference of the internal vessel (200).

The dispenser further includes an elastic steel band (420) in an outer circumference of the internal vessel (200) and a plurality of elastic steel pieces (421) in which a part of the steel band (420) is cut out cut to stand, so that the elastic steel piece (421) is gradually risen as maintaining a state where an end part reaches in contact with each other with the inner surface of the outer container (300) according as the contents within the internal vessel (200) is gradually discharged.

The invention is an environment friendly product which can discharge the contents with the compressed air filled between the internal vessel and the external container.

And, the invention achieves environment-friendly products to solve the above problems and most ideal products to meet the green growth project of the government, while the products, which very much comes out in the market, mixed the freon gas with the liquid gas causes harmful influence for the human body and regarded as the main cause of the greenhouse gas.

### TECHNICAL FIELD

The invention relates to a dispenser, and particularly to a dispenser which is enable to recharge contents in an internal vessel and discharge the contents within the internal vessel to the maximum.

Particularly, the invention relates to the dispenser which uses the environment-friendly air harmlessing in the human body, as not using the general freon gas, to improve the discharge power (draw-off force) of contents with the compressed air which is filled between an internal vessel and an outer container.

### BACKGROUND ART

The cosmetic of the liquid or mucoid is stored in dispenser in order to easily discharge the predetermined amounts.

The dispenser includes a pumping unit installed onto an upper end of a container in which the contents is stored.

As described in detail to the dispenser, the dispenser includes a nozzle formed in one side and a button for flowing out the contents through the nozzle, thereby discharging the contents, if the button is pressed and the dispenser is pumped.

The conventional dispenser is applied to products which mixes air with the liquid such as hair mousse or shave form etc and uses the compressed gas like the freon gas.

Accordingly, the conventional dispenser still has the danger of the explosion or the fire and the harmfulness for human body, cause the environmental pollution such as the ozone layer destruction etc., and not allowing the recharge of contents.

### SUMMARY OF INVENTION

### Problem to be Solved

Accordingly, the invention is conceptualized with the consideration of the above problem and thus an object thereof is to provide a dispenser which enable to recharge of contents without injecting the gas causing the explosion or the fires.

Moreover, the present invention is to provide a dispenser which is enable to discharge the contents within the internal vessel to the maximum.

Particularly, the present invention is to provide a dispenser which uses the environment-friendly air harmlessing in the human body, as not using the freon gas like the conventional manner, thereby improving the discharge power (draw-off force) of contents with the compressed air which is filled between the internal vessel and the outer container.

### Means to Solve the Problem

To achieve the above object, there is provided to a dispenser comprises: an outer container (300), an internal vessel (200) for storing contents and inserted inside the outer container (300), and a pumping part (100) combined in an upper part of the internal vessel (200) and for discharging the contents in the internal vessel (200);

the internal vessel is composed with a material capable of the contraction and expansion; a plurality of wrinkles (210) are formed through a blow injection manner; and the connecting rod (220) for coupling with the pumping part (100), an elastic steel band (420) formed in the outer circumference of the internal vessel (200), and a plurality of an elastic steel pieces (421) formed by cutting out a part of the steel band (420) to stand are formed onto the upper part of the internal vessel, respectively;
the elastic steel piece (421) is gradually risen as the contents within the internal vessel (200) is gradually discharged, as maintaining a state where an end part reaches in contact with each other with an inner surface of the outer container (300);
the contents is discharged (or exhausted) by the compressed air (301) by filling between the outer container (300) and the internal vessel (200).

The dispenser further comprises a compression rubber band (410) in an outer circumference of the internal vessel (200).

The dispenser further according to the present invention includes an elastic steel band (420) in an outer circumference of the internal vessel (200) and a plurality of elastic steel pieces (421) in which a part of the steel band (420) is cut out cut to stand, so that the elastic steel piece (421) is gradually risen as maintaining a state where an end part reaches in contact with each other with the inner surface of the outer container (300) according as the contents within the internal vessel (200) is gradually discharged.

### Effects of the Invention

As described above, the dispenser of the present invention has the advantage that the contents can be recharged without injecting the gas causing the explosion or the fires.

Moreover, the dispenser of the present invention has the advantage that the contents is discharged within the internal vessel to the maximum.

Moreover, the invention can improve the discharge power (draw-off force) of the contents with the compressed air which is filled between the internal vessel and the outer container. Moreover, the invention can obtain an environment friendly product which can discharge the contents with the compressed air filled between the internal vessel and the external container. And the invention can achieve the environment-friendly products to solve the above problems and most ideal products to meet the green growth project of the government, while the products, which very much comes out in the market, mixed the freon gas with the liquid gas causes harmful influence for the human body and regarded as the main cause of the greenhouse gas.

### BRIEF EXPLANATION OF THE DRAWINGS

FIG. 1 is an exploded perspective view of a dispenser according to a preferred embodiment of the present invention.

FIG. 2 is a combination perspective view of a dispenser according to a preferred embodiment of the present invention.

FIG. 3 is a front view of a dispenser according to a preferred embodiment of the present invention.

FIG. 4 is a perspective view showing a state where the internal vessel of the dispenser of FIG. 2 is swelled.

FIG. 5 is a perspective view of dispenser according to other preferred embodiment of the present invention.

FIG. 6 is a perspective view showing a state where the internal Vessel of the dispenser of the FIG. 5 is swelled.

FIG. 7 is a perspective view of a dispenser according to the other preferred embodiment of the invention.

FIG. 8 is a perspective view showing a state where the internal vessel of the dispenser FIG. 7 is swelled.

### DESCRIPTION OF EMBODIMENTS

Below, a preferred exemplary embodiment of the invention will be described in details with reference to the accompanying drawings.

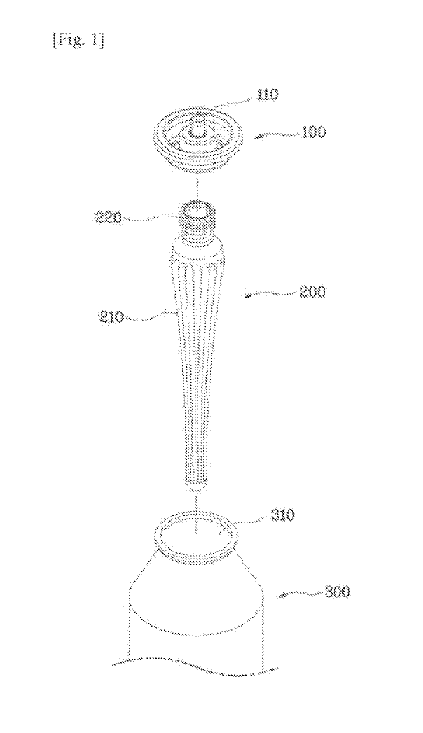

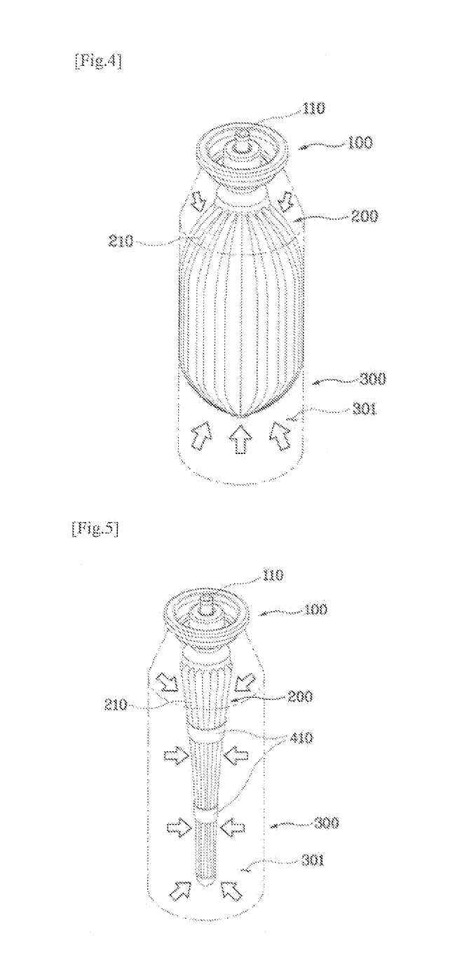

FIGS. 1 through 3 are exploded perspective view, a combination perspective view, and a front view of the dispenser according to preferred embodiments of the present invention, and show a state that the internal vessels are shrinked, and FIG. 4 is a perspective view showing a state where the internal vessel of the dispenser of FIG. 2 is swelled.

Referring to the FIGS. 1 through 4, the dispenser of the present invention comprises a plurality of pumping part (100), an internal vessel (200) and an outer container (300).

The outer container (300) has an opening onto an upper part, and a fastener (310) for coupling with the pumping part (100) is formed onto an upper part of the container.

Moreover, the outer container (300) is composed of the material in which the deformation is impossible, and a plastic of the solidity or a metal material is used as a preferred example.

The compressed air (301) is filled within the outer container (300). The power (displayed as arrow mark) of the compressed air (301) actuates on the internal vessel (200), when the contents within the internal vessel (200) is discharged (exhausted).

The internal vessel (200) is used to store the contents of the liquid or the gel shape and inserted inside the outer container (300), and the connecting rod (220) for coupling with the pumping part (100) is formed into an upper part of the container.

Moreover, the internal vessel (200) is made by the material capable of contracting and expanding material, and a plurality of wrinkles (210) is formed through the blow injection manner.

For example, the internal vessel (200) is used with tough and non pollutants film (as example: PPT, PET etc).

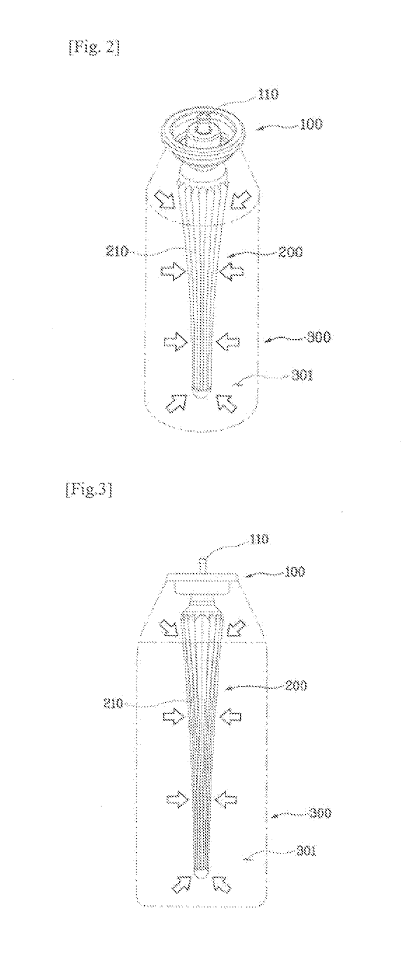

The wrinkle (210) is formed into the upward and the downward directions. The wrinkle swells and gradually gets unfolded as shown in FIG. 3, as the contents is filled within the internal vessel (200). At this time, the expansion can be performed until an exterior of the internal vessel (200) touches to an inner surface of the outer container (300).

The pumping part (100) discharges the contents within the internal vessel (200) and is combined in a fastener (310) and a connecting rod (220) equipped onto the upper end of the internal vessel (200) and outer container (300), respectively.

More specifically, the pumping part (100) includes a nozzle (non illustration) is formed in one side and a button (non illustration) in which the contents is flown out through the nozzle. That is, the contents is discharged if the button is pressed and also the dispenser is pumped. Accordingly, the push part (110) of FIG. 1 is pressurized if the button is pressed, then the vacuum pressure is occurred since the spring (non illustration) connected to the push unit (110) is compressed, thereby opening a discharge hole to be discharged the contents through the discharge hole to outside.

A check valve is installed into the pumping part (100) to prevent form flowing the contents reversely.

As described above, the internal vessel (200) is gradually crumpled (or contracted) according as the contents within the internal vessel (200) is gradually discharged.

The pumping part (100) can replaced with the pumping part of the conventional dispenser. That is, the conventional pumping part are described in KR Utility Model Registration No. 2000-14083(Title: dispenser), KR Utility Model Registration 2000-36103(Title: dispenser container) etc.

The invention fills the compressed air (301) within the outer container (300). That is, the discharge power of the contents can be improved more with this compressed air (301) according to fill the compressed air (301) between the outer container (300) and the internal vessel (200).

Particularly, the invention is very useful in that it uses the environment-friendly air harmlessing in the human body, while it does not use the freon gas like the convention manner.

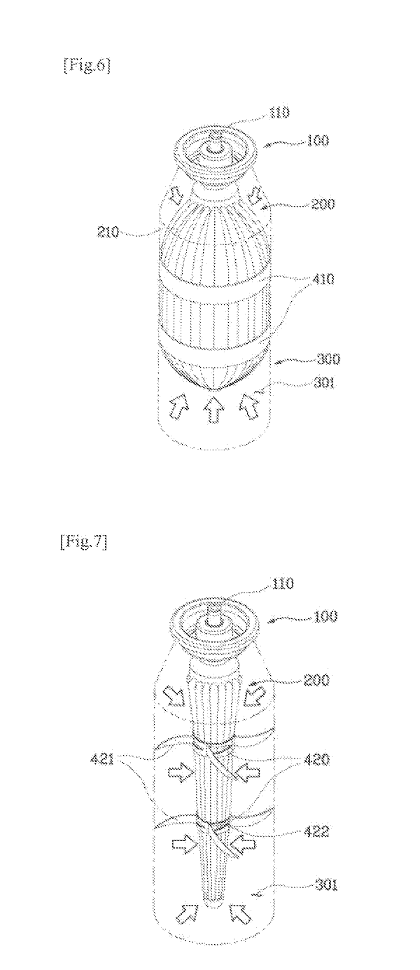

FIG. 5 is a perspective view of dispenser according to other preferred embodiment of the present invention, and FIG. 6 is a perspective view showing a state where the internal vessel of the dispenser of the FIG. 5 is swelled.

The dispenser, shown in FIGS. 5 and 6, further includes a compression rubber band (410) in the outer circumference of the internal vessel (200), as comparing to the dispenser of the FIGS. 1 through 4.

The rubber band (410) has the elastic property, thereby contracting as the contents is discharged.

As described above, according to constitute the rubber band (410) in the outer circumference of the internal vessel (200), the discharge power of the contents can be improved with the tightening force of the rubber band (410), and the discharging of the contents can be maximized to the utmost in the internal vessel (200).

FIG. 7 is a perspective view of a dispenser according to the other preferred embodiment of the invention.

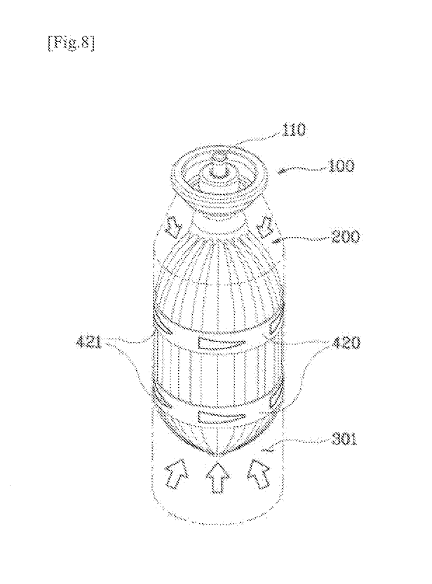

FIG. 8 is a perspective view showing a state where the internal vessel of the dispenser FIG. 7 is swelled.

The dispenser, as shown in FIGS. 7 and 8, further includes a elastic steel band (420) in the outer circumference of the internal vessel (200), as comparing to the dispenser of the FIGS. 1 through 4.

The steel band (420) is formed with strip-shaped. A plurality of elastic steel pieces (421) in which one part is cut out cut to stand is formed onto the steel band (420). Accordingly, a cutout hole (422) is formed in an incision part of the steel band (420).

The elastic steel piece (421) as shown in FIG. 8 reaches to the location of the cutout hole (422), if the contents is filled within the internal vessel (200) to the maximum. As the contents is gradually discharged, the elastic steel piece (421) is more and more risen as shown in FIG. 7.

At this time, the end part of the elastic steer piece (421) maintains the state reaching in contact with each other with the inner surface of the outer container (300).

Accordingly, the elastic steel piece (421) is gradually risen as the internal vessel (200) is gradually shrinked, the elastic steel piece (421) gradually lays down as the internal vessel (200) is gradually swelled on the contrary.

As described above, according to constitute the elastic steel piece, (421) in the outer circumference of the internal vessel (200), the discharge power of the contents can be improved and the discharging of the contents can be maximized to the utmost in the internal vessel (200).

As described above, it will be able to understand to be various, can change the invention in the range that it does not escape with reference to the preferred embodiment of the present invention from the thought and domain of the invention in below patent claim the skilled person skilled in the art of the target technology part it explained with correction.

### DESCRIPTION OF MAIN PARTS OF FIGURES

100: pumping part
110: push part
200: internal vessel
210: wrinkle
220: connecting rod
300: outer container
301: compressed air
310: fastener
410: compression rubber bend
420: elastic steel bend
421: elastic steel piece
422: cutout hole

1. A dispenser comprises: an outer container (300), an internal vessel (200) for storing contents and inserted inside the outer container (300), and a pumping part (100) combined in an upper part of the internal vessel (200) and for discharging the contents in the internal vessel (200);
the internal vessel is composed with a material capable of the contraction and expansion; a plurality of wrinkles (210) are formed through a blow injection manner; and the connecting rod (220) for coupling with the pumping part (100), an elastic steel band (420) formed in the outer circumference of the internal vessel (200), and a plurality of an elastic steel pieces (421) formed by cutting out a part of the steel band (420) to stand are formed onto the upper part of the internal vessel, respectively;
the elastic steel piece (421) is gradually risen as the contents within the internal vessel (200) is gradually discharged, as maintaining a state where an end part reaches in contact with each other with an inner surface of the outer container (300);
the contents is discharged (or exhausted) by the compressed air (301) by filling between the outer container (300) and the internal vessel (200).

2. The dispenser according to claim 1, a compression rubber band (410) is further includes in an outer circumference of the internal vessel (200).

3. (canceled)
